(19) United States
(12) Patent Application Publication
(10) Pub. No.: US 2025/0138382 A1
(43) Pub. Date: May 1, 2025

(54) REFLECTIVE DISPLAY AND PROJECTED CAPACITIVE TOUCH SENSOR WITH SHARED TRANSPARENT ELECTRODE

(71) Applicant: E INK CORPORATION, Billerica, MA (US)

(72) Inventors: Stephen J. TELFER, Arlington, MA (US); Hjalmar Edzer Ayco HUITEMA, Lexington, MA (US); Ian FRENCH, Hsinchu (TW); Karl Raymond AMUNDSON, Cambridge, MA (US)

(21) Appl. No.: 18/899,661

(22) Filed: Sep. 27, 2024

Related U.S. Application Data
(60) Provisional application No. 63/546,551, filed on Oct. 31, 2023.

(51) Int. Cl. G02F 1/1685; G02F 1/167; G02F 1/1676

(52) U.S. Cl. CPC G02F 1/1685; G02F 1/167; G02F 1/1676

(57) ABSTRACT

A touch-enabled electro-optic display device has a stack of layers including, in order: a first electrode layer at a viewing surface of the touchscreen electro-optic display device; a dielectric layer; a second electrode layer; a semi-conductive layer; an electro-optic medium layer; and a third electrode layer. The second electrode layer, the semi-conductive layer, the electro-optic medium layer, and the third electrode layer form an electro-optic device in which the electro-optic medium layer is addressed by applying a driving voltage to the third electrode layer while holding the voltage on the second electrode layer constant. The first electrode layer, the dielectric layer, and the second electrode layer form a capacitive touch sensor that detects a touch input by sensing a change in capacitance at a touched point on the first electrode layer.

### RELATED APPLICATIONS

This application claims priority from U.S. Provisional Patent Application No. 63/546,551 filed on Oct. 31, 2023 entitled REFLECTIVE DISPLAY AND PROJECTED CAPACITIVE TOUCH SENSOR WITH SHARED TRANSPARENT ELECTRODE, which is hereby incorporated by reference in its entirety.

### BACKGROUND OF INVENTION

The present invention relates generally to touch-enabled reflective electro-optic displays and, more particularly, to electrophoretic display devices having a projected capacitive touch sensor using a shared transparent electrode for improved optical performance.

Electrophoretic displays change color by modifying the positions of charged colored particles with respect to a light-transmissive viewing surface. They are typically referred to as “electronic paper” or “ePaper” because the resulting display has high contrast and is sunlight-readable, much like ink on paper. Electrophoretic displays have enjoyed widespread adoption in eReaders, such as the AMAZON KINDLE® because the displays provide a book-like reading experience, use little power, and allow a user to carry a library of hundreds of books in a lightweight handheld device.

Electrophoretic displays and other modern electronic displays commonly include touch sensors for receiving user touch inputs. Touch sensor technologies include resistive touch sensors (which detect changing resistance between two surfaces resulting from mechanical deformation), frustrated total internal reflection (which detects interruption of total internal reflection by optical coupling of an object to a waveguide at a display surface), surface acoustic wave detection and, most commonly, capacitive sensing methods. One of the most versatile capacitive sensing techniques is projected capacitive sensing, which uses a row and column array of thin conducting electrodes separated by a nonconductive material. Because the human body is electrically conductive, touching or approaching the sensing surface with a fingertip changes the coupling capacitance between electrode wires at the intersecting row and column grid positions of the grid array. This change in capacitance can be measured in several ways including, e.g., by measuring a change in voltage for a given charge on the grid or a change in an RC-time constant. Projected capacitive sensing is a particularly useful technique because, unlike earlier capacitive sensing methods, it enables detection of multiple simultaneous touch events.

This disclosure describes combining the function of one of the electrode layers of a projected capacitive touch sensor array with that of a transparent driving electrode of an electrophoretic display to improve optical performance.

### SUMMARY OF INVENTION

A touch-enabled electro-optic display device according to a first aspect of the invention comprises a multilayer stack of layers including, in order: a first electrode layer at a viewing surface of the touchscreen electro-optic display device; a dielectric layer; a second electrode layer; a semi-conductive layer; an electro-optic medium layer; and a third electrode layer. The second electrode layer, the semi-conductive layer, the electro-optic medium layer, and the third electrode layer form an electro-optic device in which the electro-optic medium layer is addressed by applying a driving voltage to the third electrode layer while holding the voltage on the second electrode layer constant. The first electrode layer, the dielectric layer, and the second electrode layer form a capacitive touch sensor that detects a touch input by sensing a change in capacitance at a touched point on the first electrode layer.

In one or more embodiments, the first electrode layer and the second electrode layer include a plurality of electrodes forming a row and column grid.

In one or more embodiments, the plurality of electrodes of the second electrode layer are disposed in the semi-conductive layer, which is configured to promote blooming in gaps between adjacent electrodes.

In one or more embodiments, the semi-conductive layer comprises an ionically-conductive layer.

In one or more embodiments, the ionically-conductive layer includes a polymer material containing an ionic dopant.

In one or more embodiments, the semi-conductive layer has a thickness of about 2 to 50 micrometers and/or a resistivity of about 10³ to 10⁷ Ω·cm.

In one or more embodiments, the semi-conductive layer has a thickness of about 5 to 25 micrometers.

In one or more embodiments, the electro-optic device and the capacitive touch sensor operate at different times.

In one or more embodiments, each time frame for refreshing the electro-optic device includes a first temporal portion for addressing the optic medium layer and a separate second temporal portion for detecting touch inputs.

In one or more embodiments, the device further comprises a light guide plate and cover lens on a side of the first electrode layer opposite the dielectric layer.

In one or more embodiments, the third electrode layer comprises an array of pixel electrodes in a backplane.

In one or more embodiments, the electro-optic medium comprises charged pigment particles dispersed in a non-polar solvent.

In one or more embodiments, the electro-optic medium layer comprises an encapsulated electrophoretic medium.

In one or more embodiments, the encapsulated electrophoretic medium comprises an electrophoretic medium encapsulated in microcapsules or microcups.

In one or more embodiments, the electro-optic medium is bistable.

In one or more embodiments, the first, second, or third electrode layers comprise (a) a material selected from the group consisting of aluminum tin oxide, indium-tin-oxide, poly(3,4-ethylenedioxythiophene), and combinations thereof, (b) an organic material, (c) a composite material, or (d) a sparse grid.

In one or more embodiments, the device does not contain indium tin oxide.

In one or more embodiments, the first electrode layer and the second electrode layer are light-transmissive.

A method of manufacturing a touchscreen electro-optic display device according to a further aspect of the invention comprises the steps of: (a) providing an electro-optic medium layer; (b) laminating one side of the electro-optic medium layer to a pixelated backplane; and (c) laminating an opposite side of the electro-optic medium layer to a layered structure comprising a first electrode layer, a second electrode layer, and a dielectric layer between the first and second electrode layers, wherein the second electrode layer is adjacent the electro-optic medium layer and the first electrode layer is at a viewing surface of the touchscreen electro-optic display device, wherein the first electrode layer and the second electrode layer include a plurality of electrodes forming a row and column grid, and wherein the plurality of electrodes of the second electrode layer are disposed in a semi-conductive layer configured to promote blooming in gaps between the electrodes.

A method of manufacturing a touchscreen electro-optic display device according to a further aspect of the invention comprises the steps of: (a) providing an electro-optic medium layer; (b) laminating one side of the electro-optic medium layer to a layered structure comprising a first electrode layer, a second electrode layer, and a dielectric layer between the first and second electrode layers, wherein the second electrode layer is adjacent the electro-optic medium layer and the first electrode layer is at a viewing surface of the touchscreen electro-optic display device, wherein the first electrode layer and the second electrode layer include a plurality of electrodes forming a row and column grid, and wherein the plurality of electrodes of the second electrode layer are disposed in a semi-conductive layer configured to promote blooming in gaps between the electrodes; and (c) laminating an opposite side of the electro-optic medium layer to a pixelated backplane.

In one or more embodiments, providing the electro-optic medium layer comprises: (i) embossing microcups on a primer layer disposed on a substrate; (ii) filling the microcups with an electrophoretic fluid; and (iii) sealing the microcups with a polymeric sealing layer.

In one or more embodiments, providing the electro-optic medium layer comprises: encapsulating an electrophoretic medium in microcapsules and distributing the microcapsules in a binder to make a slurry to be coated onto the pixelated backplane or the layered structure.

In one or more embodiments, laminating one side of the electro-optic medium layer to a pixelated backplane comprises: (i) laminating a substrate coated with an adhesive layer to the polymeric sealing layer of the electro-optic medium layer; (ii) removing substrate; and (iii) laminating the pixelated backplane to the adhesive layer.

In one or more embodiments, laminating the opposite side of the electro-optic medium layer to the layered structure comprises laminating the primer layer of the electro-optic medium layer to the second electrode layer of the structure.

In one or more embodiments, the method further comprises attaching a light guide plate and cover lens on a side of the first electrode layer opposite the dielectric layer.

### BRIEF DESCRIPTION OF DRAWINGS

FIG. 1 is a simplified diagram illustrating an exemplary prior art electrophoretic device.

FIG. 2 is a simplified diagram illustrating an exemplary prior thin film transistor backplane array for driving an electrophoretic device.

FIGS. 3A and 3B are simplified cross-sectional and plan view diagrams, respectively, illustrating the basic design of an exemplary prior art projected capacitive touch sensor.

FIG. 4 is a simplified cross-sectional diagram illustrating an exemplary prior art display module having a projected capacitive touch sensor.

FIG. 5 is a simplified cross-sectional diagram illustrating an exemplary reflective display module having a projected capacitive touch sensor in accordance with one or more embodiments.

FIGS. 6A-6E are simplified cross-sectional diagrams illustrating an exemplary process for manufacturing a reflective display module having a projected capacitive touch sensor in accordance with one or more embodiments.

Like reference numbers indicate like elements throughout the drawings.

### DETAILED DESCRIPTION

Various embodiments disclosed herein relate to electrophoretic or other reflective displays having a projected capacitive touch sensor using a shared transparent electrode for improved optical performance.

Electrophoretic displays have been the subject of intense research and development for a number of years. In such displays, a plurality of charged particles (sometimes referred to as pigment particles) move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, e.g., Kitamura, T., et al., Electrical toner movement for electronic paper-like display, IDW Japan, 2001, Paper HCS1-1, and Yamaguchi, Y., et al., Toner display using insulative particles charged triboelectrically, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, e.g., in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see, e.g., U.S. Pat. Nos. 7,002,728 and 7,679,814;
(b) Capsules, binders and encapsulation processes; see, e.g., U.S. Pat. Nos. 6,922,276 and 7,411,719;
(c) Microcell structures, wall materials, and methods of forming microcells; see, e.g., U.S. Pat. Nos. 7,072,095 and 9,279,906;
(d) Methods for filling and sealing microcells; see, e.g., U.S. Pat. Nos. 7,144,942 and 7,715,088;
(e) Films and sub-assemblies containing electro-optic materials; see, e.g., U.S. Pat. Nos. 6,982,178 and 7,839,564;
(f) Backplanes, adhesive layers and other auxiliary layers and methods used in displays; see, e.g., U.S. Pat. Nos. 7,116,318 and 7,535,624;
(g) Color formation color adjustment; see, e.g., U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422, 116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see, e.g., U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777 (these patents and applications may hereinafter be referred to as the MEDEOD (MEthods for Driving Electro-optic Displays) applications);
(i) Applications of displays; see, e.g., U.S. Pat. Nos. 7,312,784 and 8,009,348; and
(j) Non-electrophoretic displays, as described in U.S. Pat. No. 6,241,921; and U.S. Patent Applications Publication Nos. 2015/0277160; and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see, e.g., U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules, but instead are retained within a plurality of cavities formed within a carrier medium, typically a polymeric film. Sec, e.g., U.S. Pat. Nos. 6,672,921 and 6,788,449.

Although electrophoretic media are often opaque (since, e.g., in many electrophoretic media, the particles substantially block transmission of visible light through the display) and operate in a reflective mode, many electrophoretic displays can be made to operate in a so-called shutter mode in which one display state is substantially opaque and one is light-transmissive. Sec, e.g., U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode. See U.S. Pat. No. 4,418,346. Other types of electro-optic displays may also be capable of operating in shutter mode. Electro-optic media operating in shutter mode can be used in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

As indicated above, most simple prior art electrophoretic media essentially display only two colors. Such electrophoretic media either use a single type of electrophoretic particle having a first color in a colored fluid having a second, different color (in which case, the first color is displayed when the particles lie adjacent the viewing surface of the display and the second color is displayed when the particles are spaced from the viewing surface), or first and second types of electrophoretic particles having differing first and second colors in an uncolored fluid (in which case, the first color is displayed when the first type of particles lie adjacent the viewing surface of the display and the second color is displayed when the second type of particles lie adjacent the viewing surface). Typically the two colors are black and white. If a full color display is desired, a color filter array (CFA) may be deposited over the viewing surface of the monochrome (black and white) display. (By way of example, U.S. Pat. No. 6,862,128 discloses an electrophoretic display with a CFA.) Displays with CFAs rely on area sharing and color blending to create color stimuli. The available display area is shared between three or four primary colors such as red/green/blue (RGB) or red/green/blue/white (RGBW), and the filters can be arranged in one-dimensional (stripe) or two-dimensional (2×2) repeat patterns. Other choices of primary colors or more than three primaries are also known in the art. The three (in the case of RGB displays) or four (in the case of RGBW displays) sub-pixels are chosen small enough so that at the intended viewing distance they visually blend together to a single pixel with a uniform color stimulus (‘color blending’). The inherent disadvantage of area sharing is that the colorants are always present, and colors can only be modulated by switching the corresponding pixels of the underlying monochrome display to white or black (switching the corresponding primary colors on or off). For example, in an ideal RGBW display, each of the red, green, blue and white primaries occupy one fourth of the display area (one sub-pixel out of four), with the white sub-pixel being as bright as the underlying monochrome display white, and each of the colored sub-pixels being no lighter than one third of the monochrome display white. The brightness of the white color shown by the display as a whole cannot be more than one half of the brightness of the white sub-pixel (white areas of the display are produced by displaying the one white sub-pixel out of each four, plus each colored sub-pixel in its colored form being equivalent to one third of a white sub-pixel, so the three colored sub-pixels combined contribute no more than the one white sub-pixel). The brightness and saturation of colors is lowered by area-sharing with color pixels switched to black. Area sharing is especially problematic when mixing yellow because it is lighter than any other color of equal brightness, and saturated yellow is almost as bright as white. Switching the blue pixels (one fourth of the display area) to black makes the yellow too dark.

U.S. Pat. Nos. 8,576,476 and 8,797,634 describe multicolor electrophoretic displays having a single back plane comprising independently addressable pixel electrodes and a common, light-transmissive front electrode. A plurality of electrophoretic layers are disposed between the back plane and the front electrode. Displays described in these patents are capable of rendering any of the primary colors (red, green, blue, cyan, magenta, yellow, white and black) at any pixel location. However, there are disadvantages to the use of multiple electrophoretic layers located between a single set of addressing electrodes. The electric field experienced by the particles in a particular layer is lower than would be the case for a single electrophoretic layer addressed with the same voltage. In addition, optical losses in an electrophoretic layer closest to the viewing surface (e.g., caused by light scattering or unwanted absorption) may affect the appearance of images formed in underlying electrophoretic layers.

Two other types of electrophoretic systems provide a single electrophoretic medium capable of rendering any color at any pixel location. Specifically, U.S. Pat. No. 9,697,778 describes a display in which a dyed solvent is combined with a white (light-scattering) particle that moves in a first direction when addressed with a low applied voltage and in the opposite direction when addressed with a higher voltage. When the white particles and the dyed solvent are combined with two additional particles of opposite charge to the white particle, it is possible to render a full-color display. However, the color states of the '778 patent are not acceptable for applications such as a text reader. In particular, there will always be some of the dyed fluid separating the white scattering particle from the viewing surface, which leads to a tint in the white state of the display.

A second form of electrophoretic medium capable of rendering any color at any pixel location is described in U.S. Pat. No. 9,921,451. In the '451 patent, the electrophoretic medium includes four particles: white, cyan, magenta and yellow, in which two of the particles are positively-charged and two negatively charged. However displays of the '451 patent also suffer from color mixing with the white state. Because one of the particles has the same charge as the white particle, some quantity of the same-charge particle moves with the white toward the viewing surface when the white state is desired. While it is possible to overcome this unwanted tinting with complex waveforms driving the display, such waveforms greatly increase the update time of the display and in some instances, result in unacceptable “flashing” between images.

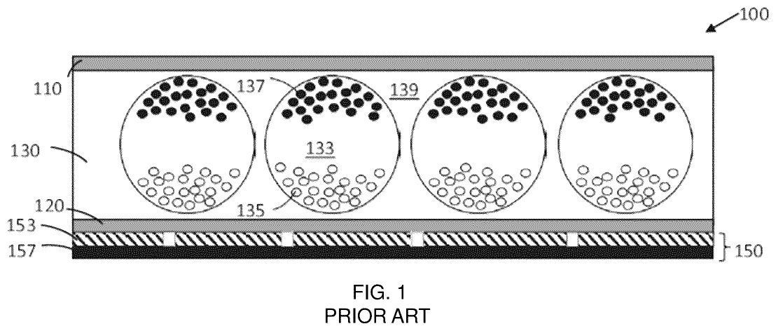

FIG. 1 is a simplified diagram (not to scale) illustrating one example of a prior art electrophoretic display as disclosed in U.S. Pat. No. 10,324,577. A display 100 comprises a layer of electrophoretic material 130 and at least two other layers 110 and 120 disposed on opposed sides of the electrophoretic material 130, at least one of these two layers being an electrode layer, e.g., as depicted by layer 110 in FIG. 1. The front electrode 110 may represent the viewing side of the display 100, in which case the front electrode 110 may be a transparent conductor, such as Indium Tin Oxide (ITO) (which in some cases may be deposited onto a transparent substrate, such as polyethylene terephthalate (PET)). The display 100 also includes a backplane 150 comprising a plurality of driving electrodes 153 and a substrate layer 157. The layer of electrophoretic material 130 may include microcapsules 133, holding electrophoretic pigment particles 135 and 137 and a solvent, with the microcapsules 133 dispersed in a polymeric binder 139. Nonetheless, it is understood that the electrophoretic medium (particles 135 and 137 and solvent) may be enclosed in microcells (microcups) or distributed in a polymer without a surrounding microcapsule. Typically, the pigment particles 137 and 135 are controlled (displaced) with an electric field produced between the front electrode 110 and the pixel electrodes 153. In many conventional electrophoretic displays, the electrical driving waveforms are transmitted to the pixel electrodes 153 via conductive traces (not shown) that are coupled to thin-film transistors (TFTs) that allow the pixel electrodes to be addressed in a row-column addressing scheme. In some embodiments, the front electrode 110 is merely grounded and the image driven by providing positive and negative potentials to the pixel electrodes 153, which are individually addressable. In other embodiments, a potential may also be applied to the front electrode 110 to provide a greater variation in the fields that can be provided between the front electrode and the pixel electrodes 153.

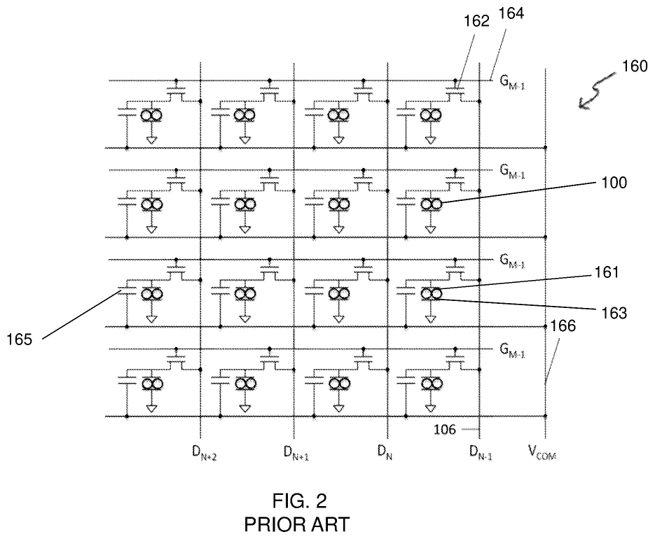

In many embodiments, the TFT array forms an active matrix 160 for image driving, as shown in FIG. 2. For example, each pixel electrode 161 (corresponding to 153 in FIG. 1) is coupled to a thin-film transistor 162 patterned into an array, and connected to gate (row) driver lines 164 and source (column) driver lines 106, running at right angles to the gate driver lines 164. Also, typically, the common (top) light-transparent electrode 163 (corresponding to 110 in FIG. 1) has the form of a single continuous electrode while the other electrode or electrode layer is patterned into a matrix of pixel electrodes 161, each of which defines one pixel of the display. Between the pixel electrode 161 and the common electrode 163, an electrophoretic medium 100 can be disposed. Any of the electrophoretic media described above may be used. A source driver (not shown) is connected to the source driver lines 106 and provides source voltage to all TFTs 162 in a column that are to be addressed. A gate driver (not shown) is connected to the gate driver lines 164 to provide a bias voltage that will open (or close) the gates of each TFT 162 along the row. The gate scanning rate is typically ˜60-150 Hz. When the TFTs 162 are n-type, taking the gate-source voltage positive allows the source voltage to be shorted to the drain. Taking the gate negative with respect to the source causes the drain source current to drop and the drain effectively floats. Because the scan driver acts in a sequential fashion, there is typically some measurable delay in update time between the top and bottom row electrodes. It is understood that the assignment of “row” and “column” electrodes is somewhat arbitrary and that a TFT array could be fabricated with the roles of the row and column electrodes interchanged. Each pixel of the active matrix 160 also includes a storage capacitor 165. The storage capacitors 165 are typically coupled to Vcom line 166. In some embodiments, the common light-transparent electrode 163 is coupled to ground, as shown in FIG. 2. In other embodiments, the common light-transparent electrode 163 is also coupled to Vcom line 166 (not shown in FIG. 2).

While electrophoretic display media are described as “black/white,” they are typically driven to a plurality of different states between black and white to achieve various tones or “greyscale.” Additionally, a given pixel may be driven between first and second grayscale states (which include the endpoints of white and black) by driving the pixel through a transition from an initial gray level to a final gray level (which may or may not be different from the initial gray level). The term “waveform” will be used to denote the entire voltage against time curve used to effect the transition from one specific initial gray level to a specific final gray level. Typically, such a waveform will comprise a plurality of waveform elements; where these elements are essentially rectangular (i.e., where a given element comprises application of a constant voltage for a period of time); the elements may be called “pulses” or “drive pulses.” The term “drive scheme” denotes a set of waveforms sufficient to effect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible to use more than one drive scheme simultaneously in different areas of the same display, and a set of drive schemes used in this manner may be referred to as “a set of simultaneous drive schemes.”

The manufacture of a three-layer electrophoretic display normally involves at least one lamination operation. For example, in several of the aforementioned patents and applications, there is described a process for manufacturing an encapsulated electrophoretic display in which an encapsulated electrophoretic medium comprising capsules in a binder is coated onto a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate. Separately, a backplane (see FIG. 1), containing an array of pixel electrodes and an appropriate arrangement of conductors to connect the pixel electrodes to drive circuitry (see FIG. 2), is prepared. To form the final display, the substrate having the capsule/binder layer thereon is laminated to the backplane using a lamination adhesive. Where it is desired to have additional non-transparent layers, such as a digitizing sensor layer (Wacom Technologies, Portland, OR), those layers are typically inserted below the electrophoretic display layer. The backplane may be flexible or mounted on glass and is typically made using multilayer photolithographic patterning. The so-called “front plane laminate” comprising the electrophoretic composition is laminated to the backplane using an electrically conductive adhesive layer.

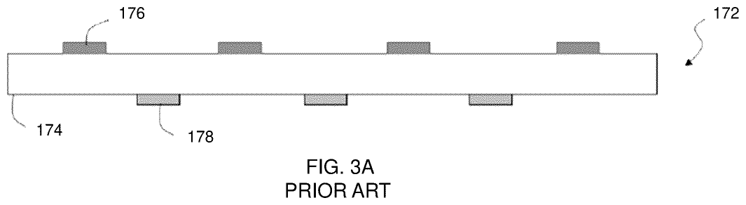

FIGS. 3A and 3B are simplified cross-sectional and plan views, respectively, illustrating the basic design of an exemplary prior art projected capacitive touch sensor 172. Such projected capacitive touch sensors as well as controller chips for processing touch inputs are commercially available from various sources including, e.g., Zytronic, 3M, Densitron, and Elo Touch Solutions.

The touch sensor 172 has an array structure comprising a plurality of row and column electrodes 176 and 178 separated by a dielectric layer 174. The array structure typically covers the entire viewing surface of the display.

For emissive displays, optical absorption by the layers 176 and 178 contributes negligibly to the appearance of the display. However, this is not the case for electrophoretic and other reflective displays, in which any absorption of light before it reaches the electrophoretic display surface will degrade image quality, particularly that of the white (reflecting) state. It is not uncommon for touch sensors comprising transparent electrodes made from indium tin oxide (ITO) to cause a loss of 5-10 L* in the white state of an electrophoretic display.

The electrode pattern shown in FIG. 3B is typically employed for relatively nonconductive materials such as ITO. As shown, the combination of the two sensing electrode arrays essentially covers the entire area of the display. While the ITO pattern can be made in a single plane with the diamond shapes connected by “bridges” separated by an insulator from the plane of the electrodes, the ITO pattern will still cover a large proportion of the display surface, resulting in optical degradation.

Wire grids made from materials more conductive than ITO, e.g., copper or silver, have a much lower area coverage of the conductor and consequently lower optical degradation of the display image by the touch sensor. However, even sparse grids made with these materials may absorb about 5-10% of incident light. It would therefore be desirable to reduce light-absorbing conductive material and interfaces between layers (which contribute Fresnel losses if they are not refractive index-matched) from the display module.

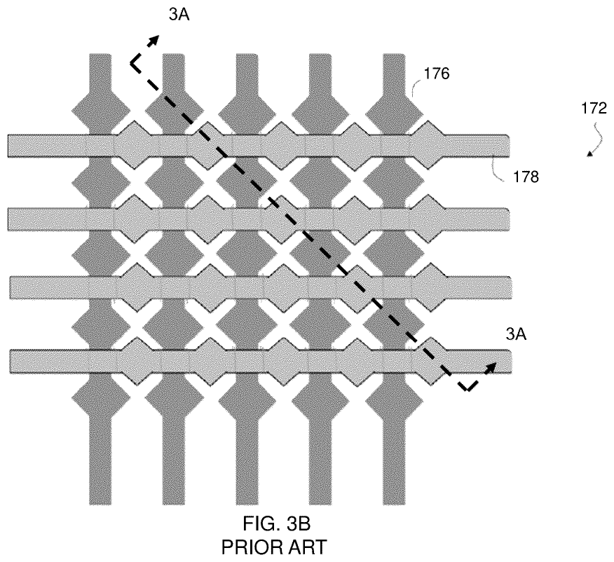

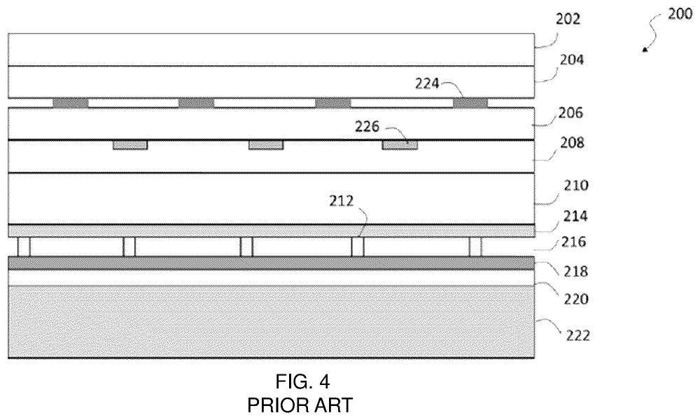

FIG. 4 is a cross-sectional view of a prior art display module 200 having a projected capacitive touch sensor. A TFT backplane array 222 is laminated to a front plane that includes an electrophoretic medium 216 compartmentalized by walls 212 defining microcups. (In other embodiments, the electrophoretic medium may be compartmentalized in microcapsules.) The microcups are closed by a sealing layer 218 and bonded to the backplane 222 using conductive adhesive layer 220. The electrophoretic medium 216 is addressed using pixel electrodes disposed on the backplane 222 and a transparent common electrode 214 on the opposite side of the medium. Overlying the common electrode 214 are a plurality of layers 210 that typically include a substrate such as polyethylene terephthalate (PET) used in the roll-to-roll process for embossing the microcups, bonded by an optically clear adhesive to a protective layer that is a moisture and UV barrier.

The touch sensor electrodes 224 and 226 are on opposite sides of a dielectric film layer 206 and bonded to the electrophoretic display using optically clear adhesive layer 208. Above the touch sensor are other layers such as a light guide plate and cover lens, shown collectively as 202, attached to the touch sensor with a layer of optically clear adhesive 204. The order of the layers above the electrophoretic medium may vary from the drawing.

As shown in FIG. 4, there are three light-absorbing conductive layers, 214, 224, and 226 overlying the electrophoretic material 216. Additional conductive layers may also be included, e.g., a shielding layer to protect the touch sensor from noise induced by switching the display.

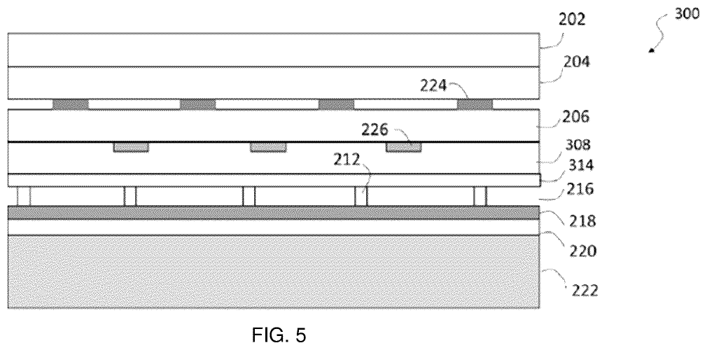

FIG. 5 illustrates a touch-enabled display device 300 in accordance with one or more embodiments of the invention. As with the device 200 of FIG. 4, the device 300 includes a TFT backplane array 222 laminated to a front plane that includes an electrophoretic medium 216 compartmentalized by walls 212 defining microcups. The microcups are closed by a sealing layer 218 and bonded to the backplane 222 using conductive adhesive layer 220.

The display device 300 also includes a projected capacitive touch sensor comprising touch sensor electrodes 224 and 226 on opposite sides of a dielectric layer 206 similar to the touch sensor of FIG. 4. The display device 300 of FIG. 5 differs from the device 200 of FIG. 4 in that the transparent electrode 214 of device 200 used in addressing the electrophoretic medium 216 is not present, and its function is instead performed by the electrodes 226 (also used in the touch sensor) and a semi-conductive (e.g., an ionically-conductive) layer or layers 308 in which the electrodes 226 are embedded. As used herein, the term “semi-conductive” refers to a conductivity that is sufficiently high to render an adequately uniform image over the entire area of the display, but low enough to permit touch sensing, as described in further detail below. Thus, the electrophoretic medium 216 is addressed using (a) pixelated electrodes on the backplane 222 and (b) the combination of the electrode grid 226 and the semi-conductive layer or layers 308 functioning as the common electrode.

The electrodes 224 and 226 may be patterned according to methods that are well known in the art, e.g., using photolithography or printing with a conductive ink.

With this arrangement, one of the light-absorbing electrode layers in the prior art modules is eliminated from the stack overlying the electrophoretic medium, thereby improving optical performance. The absence of the electrode layer raises two issues to be addressed. First, it is not possible to address the display 300 and sense touch simultaneously, since a single electrode array 226 is used for both purposes. In accordance with one or more embodiments, addressing the display and sensing touch are achieved by dividing a frame time for refreshing the display into two temporal portions: a first duration during which the backplane is scanned and addressing voltages are supplied to the storage capacitors on the display backplane, and a second duration during which touch sensing takes place. It is not necessary that sensing take place in every frame of a display's refresh, although this is preferred. Typically, sensing will add about 20% to the time required for a single frame of the display refresh. The display is not powered off during the touch sensing time, so all pixels keep their voltage levels. The common electrode voltage is superimposed on the touch sensing signal as the electrode has a dual function. This is possible as the common electrode voltage is typically DC, while the touch sensing signal is typically a low-voltage AC. Therefore during the addressing of the rows, the electrode only has the common electrode signal, while during the touch sensing period, the AC sensing signal is superimposed.

When the display is not being addressed, the touch sensor can record events continuously, and typically a user will not be interacting with the display when it is refreshing.

The second issue to be addressed due to the absence of the electrode layer is that the electrodes 226 may be too widely spaced apart for uniform addressing of the electrophoretic material. To alleviate this issue, the semi-conductive layer 308, in which the electrodes 226 are embedded, is made sufficiently conductive to allow blooming over the gap regions between adjacent electrodes 326. Such conductivity may be achieved, e.g., by providing ionic conductivity in the layer 308 in ways that are well known in the art, e.g., by including an ionic dopant in a polymer matrix. Conductivity should be increased without inducing additional optical absorption. It is preferred that layer 308 have a thickness range of about 2-50 micrometers and have a resistivity in the range of about 10³-10⁷ Ω·cm. A particularly preferred thickness is in the range 5-25 micrometers. If the layer 308 is insufficiently conductive, the pattern of electrodes 326 may be visible in an area of an image intended to be of constant optical density. However, if the conductivity is too high, the spatial resolution of the touch sensing will be reduced. U.S. Pat. No. 10,151,955 describes a variety of polymeric materials from which the layer 308 may be made. In addition, a wide variety of polymeric electrolytes have been developed for non-display applications. See, e.g., J. Mater. Chem. A, 2017, 5, 11152-11162.

Doped polymeric materials that may be used in the layer of semi-conductive polymeric material may include, but are not limited to, aliphatic or aromatic polyurethane latexes, polyacrylates, and poly(meth)acrylates containing a dopant, tetrabutylammonium hexafluorophosphate, 1-butyl-3-methylimidazolium hexafluorophosphate, polyvinyl alcohol, ionically modified polyvinyl alcohol, gelatin, polyvinyl pyrrolidone, and combinations thereof. Polymeric blends containing aromatic isocyanates are less preferred. Examples of formulations that may be included in the layer of semi-conductive polymeric material are described in U.S. Patent Application Publication No. 2017/0088758 and U.S. Pat. Nos. 7,012,735; 7,173,752; and 9,777,201.

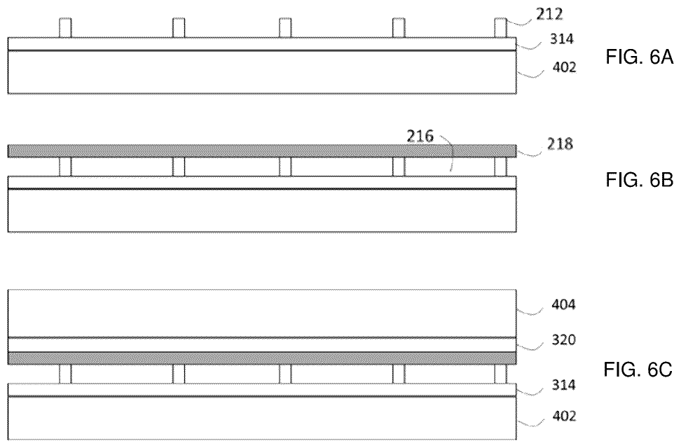

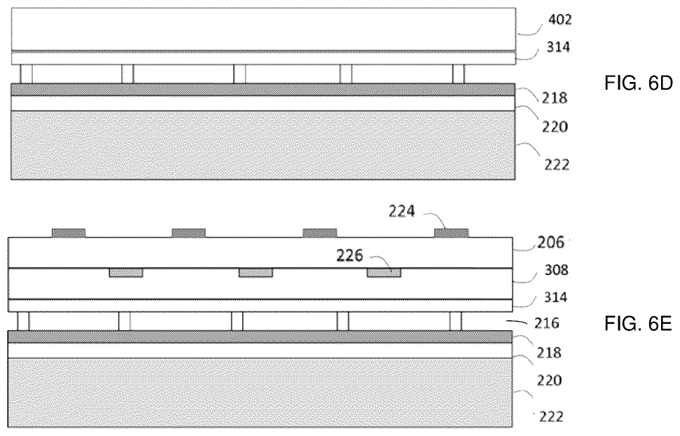

A display module 300 in accordance with one or more embodiments may be fabricated as shown in FIGS. 6A-6E, which illustrate an electrophoretic layer compartmentalized using microcups, although similar structures may be made using microcapsules.

In step (i), as shown in FIG. 6A, microcups 212 are embossed on a primer layer 314 disposed on a substrate 402. The substrate 402 bears a release coating such that it can be peeled away from layer 314.

In step (ii), as shown in FIG. 6B, the microcups are filled with electrophoretic fluid 216 and sealed with polymeric composition 218 as is well known in the art.

In step (iii), as shown in FIG. 6C, an adhesive layer 320 coated on a substrate 404, provided with a release layer, is laminated to the sealing layer 218 of the structure made in step (ii). The peel force required to remove substrate 404 from sealing layer 218 is less than that required to separate substrate 402 from primer layer 314.

In step (iv), as shown in FIG. 6D, the substrate 404 is removed and the adhesive layer 220 is laminated to a pixelated backplane 222, which may be segmented or active matrix.

In step (v), as shown in FIG. 6E, the substrate 402 is removed from the structure made in step (iv) and the substrate 206 comprising the electrode arrays 224 and 226 is laminated to primer layer 314 using a conductive, optically clear layer (or layers) 308. Layer 308 may itself have been coated onto a release substrate, laminated to either the touch assembly or the primer layer 314, following which the substrate is removed and the second lamination carried out. Additional layers such as a light guide plate and cover lens 202 may then be applied on the touch sensor with a layer of optically clear adhesive 204.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A touch-enabled electro-optic display device, comprising a multilayer stack of layers including, in order:
a first electrode layer at a viewing surface of the touchscreen electro-optic display device;
a dielectric layer;
a second electrode layer;
a semi-conductive layer;
an electro-optic medium layer; and
a third electrode layer;
wherein the second electrode layer, the semi-conductive layer, the electro-optic medium layer, and the third electrode layer form an electro-optic device in which the electro-optic medium layer is addressed by applying a driving voltage to the third electrode layer while holding the voltage on the second electrode layer constant; and
wherein the first electrode layer, the dielectric layer, and the second electrode layer form a capacitive touch sensor that detects a touch input by sensing a change in capacitance at a touched point on the first electrode layer.

2. The device of claim 1, wherein the first electrode layer and the second electrode layer include a plurality of electrodes forming a row and column grid.

3. The device of claim 2, wherein the plurality of electrodes of the second electrode layer are disposed in the semi-conductive layer, which is configured to promote blooming in gaps between the electrodes.

4. The device of claim 1, wherein the semi-conductive layer comprises an ionically-conductive layer.

5. The device of claim 4, wherein the ionically-conductive layer includes a polymer material containing an ionic dopant.

6. The device of claim 1, wherein the semi-conductive layer has a thickness of about 2 to 50 micrometers and/or a resistivity of about 10³ to 10⁷ Ω·cm.

7. The device of claim 1, wherein the electro-optic device and the capacitive touch sensor operate at different times.

8. The device of claim 1, wherein each time frame for refreshing the electro-optic device includes a first temporal portion for addressing the optic medium layer and a separate second temporal portion for detecting touch inputs.

9. The device of claim 1, further comprising a light guide plate and cover lens on a side of the first electrode layer opposite the dielectric layer.

10. The device of claim 1, wherein the third electrode layer comprises an array of pixel electrodes in a backplane.

11. The device of claim 1, wherein the electro-optic medium layer comprises an encapsulated electrophoretic medium.

12. The device of claim 1, wherein the first, second, or third electrode layers comprise (a) a material selected from the group consisting of aluminum tin oxide, indium-tin-oxide, poly(3,4-ethylenedioxythiophene), and combinations thereof, (b) an organic material, (c) a composite material, or (d) a sparse grid.

13. The device of claim 1, wherein the device does not contain indium tin oxide.

14. A method of manufacturing a touchscreen electro-optic display device, comprising the steps of:
(a) providing an electro-optic medium layer;
(b) laminating one side of the electro-optic medium layer to a pixelated backplane; and
(c) laminating an opposite side of the electro-optic medium layer to a layered structure comprising a first electrode layer, a second electrode layer, and a dielectric layer between the first and second electrode layers, wherein the second electrode layer is adjacent the electro-optic medium layer and the first electrode layer is at a viewing surface of the touchscreen electro-optic display device, wherein the first electrode layer and the second electrode layer include a plurality of electrodes forming a row and column grid, and wherein the plurality of electrodes of the second electrode layer are disposed in a semi-conductive layer configured to promote blooming in gaps between the electrodes.

15. A method of manufacturing a touchscreen electro-optic display device, comprising the steps of:
(a) providing an electro-optic medium layer;
(b) laminating one side of the electro-optic medium layer to a layered structure comprising a first electrode layer, a second electrode layer, and a dielectric layer between the first and second electrode layers, wherein the second electrode layer is adjacent the electro-optic medium layer and the first electrode layer is at a viewing surface of the touchscreen electro-optic display device, wherein the first electrode layer and the second electrode layer include a plurality of electrodes forming a row and column grid, and wherein the plurality of electrodes of the second electrode layer are disposed in a semi-conductive layer configured to promote blooming in gaps between the electrodes; and
(c) laminating an opposite side of the electro-optic medium layer to a pixelated backplane.

16. The method of claim 15, wherein step (a) comprises encapsulating an electrophoretic medium in microcapsules and distributing the microcapsules in a binder to make a slurry to be coated onto the pixelated backplane or the layered structure.

17. The method of claim 15, wherein step (a) comprises:
(i) embossing microcups on a primer layer disposed on a substrate;
(ii) filling the microcups with an electrophoretic fluid; and
(iii) sealing the microcups with a polymeric sealing layer.

18. The method of claim 17, wherein laminating the electro-optic medium layer to the layered structure comprises laminating the primer layer of the electro-optic medium layer to the second electrode layer of the layered structure.

19. The method of claim 15, wherein laminating the electro-optic medium layer to the pixelated backplane comprises:
(i) laminating a substrate coated with an adhesive layer to the polymeric sealing layer of the electro-optic medium layer;
(ii) removing substrate; and
(iii) laminating the pixelated backplane to the adhesive layer.

20. The method of claim 15, wherein the semi-conductive layer has a thickness of about 2 to 50 micrometers and/or a resistivity of about 10³ to 10⁷ Ω·cm.

21. The method of claim 15, further comprising attaching a light guide plate and cover lens on a side of the first electrode layer opposite the dielectric layer.

22. The method of claim 15, wherein the electro-optic medium layer comprises an encapsulated electrophoretic medium.

23. The method of claim 15, wherein the device does not contain indium tin oxide.
